(19) United States
(12) Patent Application Publication
(10) Pub. No.: US 2011/0316971 A1
(43) Pub. Date: Dec. 29, 2011

(54) SINGLE PIPELINE STEREO IMAGE CAPTURE

(76) Inventor: JIANPING ZHOU, Fremont, CA (US)

(21) Appl. No.: 12/824,307

(22) Filed: Jun. 28, 2010

(51) Int. Cl. H04N 13/00

(52) U.S. Cl. 348/43; 348/E13.001

(57) ABSTRACT

In some embodiments, an electronic device comprises a first camera module and a second camera module, a first receiver to receive a first set of lines of raw image data from the first camera module, a second receiver to receive a second set of lines of raw image data from the second camera module, and logic to combine the first set of lines and the second set of lines to generate combined lines of raw image data, process the combined lines of raw image data, and generate a combined image frame from the combined lines of raw image data. Other embodiments may be described.

### BACKGROUND

The subject matter described herein relates generally to the field of image processing and more particularly to systems and methods for stereo image capture.

Electronic devices such as mobile phones, personal digital assistants, portable computers and the like may comprise a camera to capture images. By way of example, a mobile phone may comprise a camera disposed on the phone to capture images. Electronic devices may be equipped with an image signal processing pipeline to capture images collected by the camera, process the images and store the images in memory and/or display the images.

Stereo image capture involves using two or more cameras to generate an image. Stereo image capture offers imaging features unavailable in conventional single-camera imaging. Thus, techniques to equip electronic devices with the ability to implement stereo imaging may find utility.

### BRIEF DESCRIPTION OF THE DRAWINGS

The detailed description is described with reference to the accompanying figures.

FIG. 1 is a schematic illustration of an electronic device, according to some embodiments.

FIG. 2 is a schematic illustration of components for use in single pipeline stereo image capture, according to embodiments.

FIG. 3 is a flowchart illustrating in image signal processor multiplexing according to some embodiments.

### DETAILED DESCRIPTION

Described herein are exemplary systems and methods for stereo image capture in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In some embodiments, the subject matter described herein enables an electronic device to collect images from multiple camera modules without the need for independent image signal processor channels. Thus, the systems and method described herein enable an electronic device to perform stereo image capture of images from multiple camera modules through a single image processor pipeline. The image signals may be stored in memory and/or displayed on a display device.

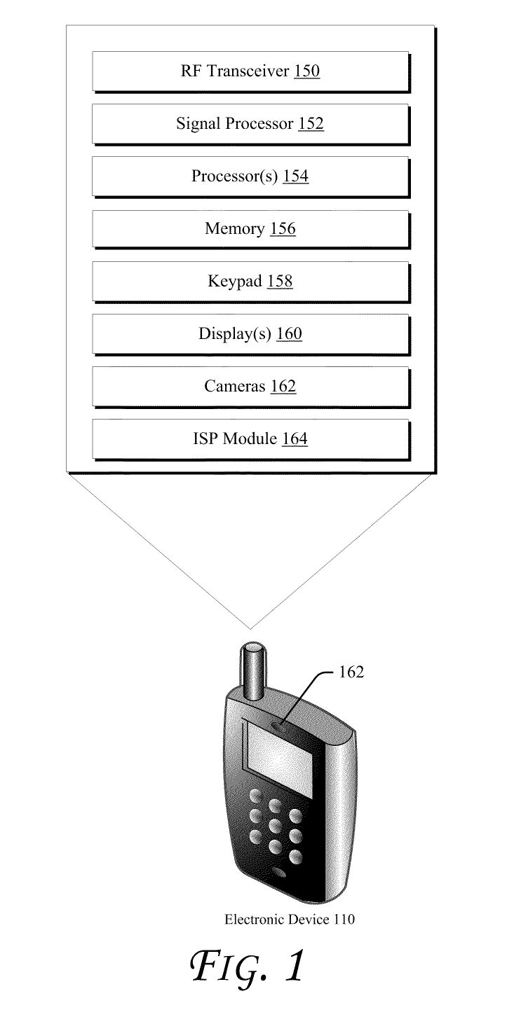

FIG. 1 is a schematic illustration of an electronic device which may be adapted to perform stereo image capture, according to some embodiments. Referring to FIG. 1, in some embodiments electronic device 110 may be embodied as a mobile telephone, a personal digital assistant (PDA) or the like. Electronic device 110 may include an RF transceiver 150 to transceive RF signals and a signal processing module 152 to process signals received by RF transceiver 150.

RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 110 may further include one or more processors 154 and a memory module 156. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 154 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design. In some embodiments, memory module 156 includes random access memory (RAM); however, memory module 156 may be implemented using other memory types such as dynamic RAM (DRAM), synchronous DRAM (SDRAM), and the like. Electronic device 110 may further include one or more input/output interfaces such as, e.g., a keypad 158 and one or more displays 160.

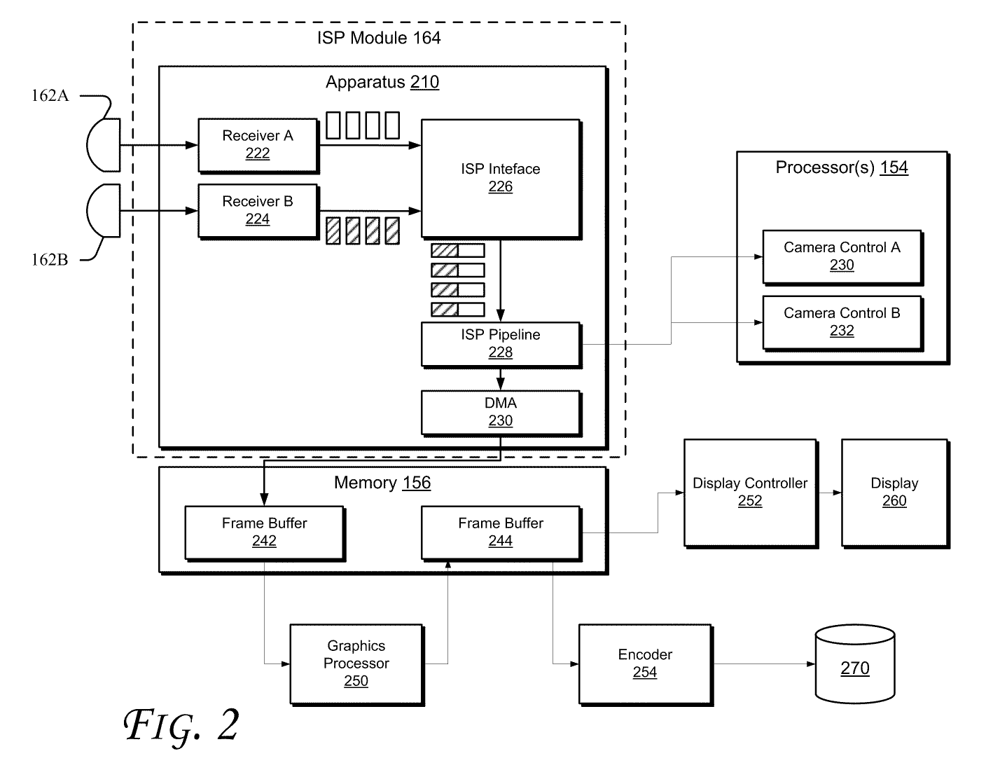

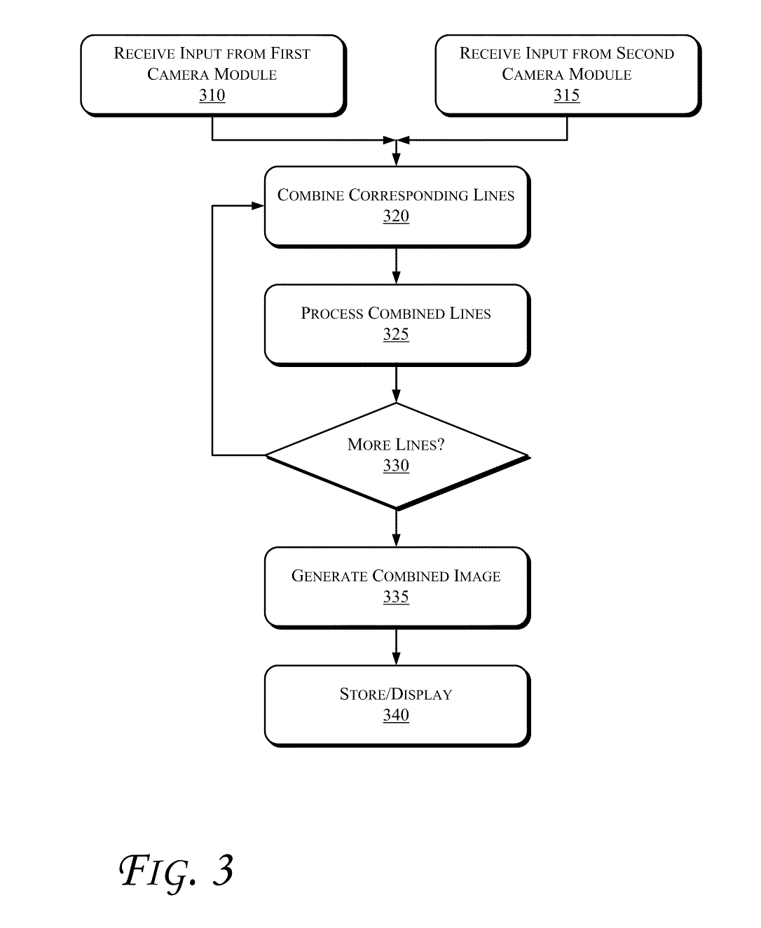

In some embodiments electronic device 110 comprises two or more camera modules 162 and an image signal processor 164. By way of example and not limitation, a first camera module 162 and a second camera module 162 may be positioned adjacent one another on the electronic device 110 such that the camera modules 162 are positioned to capture stereo images. Aspects of the camera modules and image signal processor 164 and the associated image processing pipeline will be explained in greater detail with reference to FIGS. 2-3.

FIG. 2 is a schematic illustration of components for use in stereo image capture, according to embodiments. Referring to FIG. 2, in some embodiments an image signal processor (ISP) module 164 as illustrated in FIG. 1 may be implemented as an integrated circuit, or a component thereof, or as a chipset, or as a module within a System On a Chip (SOC). In alternate embodiments the ISP module 164 may be implemented as logic encoded in a programmable device, e.g., a field programmable gate array (FPGA) or as logic instructions on a general purpose processor, or logic instructions on special processors such a Digital Signal Processor (DSP) or Single Instruction Multiple Data (SIMD) Vector Processors.

In the embodiment depicted in FIG. 2, the ISP module 164 comprises an image processing apparatus 210, which in turn comprises a first camera receiver 222 and a second camera receiver 224, an image signal processing interface 226, in image signal processing pipeline 228 and a direct memory access (DMA) engine 230. ISP module 164 is coupled to, or may include, the memory module 156 of device 110. Memory module 156 maintains a first frame buffer 242 and a second frame buffer 244. Memory module 156 is coupled to a graphics processor 250 and an encoder. The processor module 154 of device 110 may execute logic instructions for camera control units 230 and 232, which control operating parameters of the first camera 162A and the second cameral 162B, respectively.

In some embodiments the ISP module 164 adapts the electronic device 110 to implement single pipeline stereo image capture. In such embodiments, stereo images captured by multiple camera modules 162A, 162B may be processed by a single image processor pipeline 228. This enables stereo image capture with minimal changes to conventional single pipeline image processor architectures.

Structure and operations of the electronic device 110 will be explained with reference to FIGS. 2-3. In some embodiment images from a first camera module 162A are input into a first receiver 222 (operation 310) and images from a second camera module 162B are input into a second receiver 224 (operation 315). In some embodiments camera modules 162A and 162B, sometimes referred to collectively herein by the reference numeral 162, may comprise an optics arrangement, e.g., one or more lenses, coupled to an image capture device, e.g., a charge coupled device (CCD) or complementary MOS (CMOS) device. The output of the capture device may be in the format of a Bayer frame. The Bayer frames output from the CCD or CMOS device may be sampled in time to produce a series of Bayer frames, which are directed into receivers 222, 224. These unprocessed image frames may sometimes be referred to herein as raw frames. One skilled in the art will recognize that the raw image frames may be embodied as an array or matrix of data values corresponding to the outputs of the CCD or CMOS device in the camera modules 162.

The raw Bayer frames are input to an ISP interface 226, which combines the image data in the raw Bayer frames. In some embodiments the camera receivers 222, 224 release image data one line at a time, and adjacent lines are separated by a vertical blanking period. In such embodiments ISP interface 226 combines the image data from receiver A 222 and receiver B 224 on a line-by-line basis, such that corresponding lines from the receiver image data in each of receiver A 222 and receiver B 224 are logically linked into a single line. Thus, referring to FIG. 3, if at operation 330 there are more lines in the raw frame to be processed then control passes back to operation 320 and the next lines in the raw frame data are combined.

By contrast, if at operation 330 there are no more lines in the raw frame to be processed, control passes to operation 335 and a combined image is generated from the raw image data received from receiver A 222 and receiver B 224. The ISP interface forwards the combined lines of image data to the ISP pipeline 228, which processes the combined lines of image data. In some embodiments ISP pipeline processes the raw image data to generate a YUV frame.

At operation 340 the combined image is stored in a memory location and/or may be displayed on a suitable display module. DMA module 230 stores the YUV frame in a frame buffer 242. Referring to FIG. 2, in some embodiments the ISP pipeline 228 includes internal line buffers to store neighboring pixel data. The YUV frame may be input into a graphics processor 250, which may process the image for presentation on a display module. The processed image may be stored in a frame buffer 244. The processed image may then be output to a display controller 252, which presents the image on a display 260. Further, the YUV image in frame buffer 244 may be forwarded to an encoder 254, which encodes the frame for multi-view encoding. The encoded frame may be stored in a suitable storage medium 270.

In some embodiments the ISP pipeline provides a feedback mechanism that enables the camera control modules 230, 232 to modify camera control parameters in response to real-time image processing parameters. In embodiments in which the camera modules 162 are used for stereo image acquisition the camera modules will be focused on the same object at the same point in time. Therefore, the frames collected by the camera modules will have the same lighting conditions and the same content. Thus, provided the same camera modules are used, the same image processing parameters can be applied to both camera modules. However, if the camera modules are different or have different properties, the image processing parameters may need to be applied differently. Thus, camera control modules 230, 232 can control camera modules 162A, 162B differently.

The camera control modules 230, 232 use window-based image statistics to adjust various camera parameters, e.g., shutter speed, analog gain, focal distance, etc., for different lighting conditions and different scenes. The image statistics collected from incoming frames includes the windows for frames collected by both camera modules 162A, 162B. When a combined frame is being processed by the ISP pipeline 228, the statistics from a first camera module 162A are read by a first camera control module 230 and the statistics from a second camera module 162B are read by a second camera control module 232. The camera control modules 230, 232 read the data from the frames being processed by the ISP pipeline and compute new parameters for the camera modules 162A, 162B from the data. The new camera control parameters may be written into memory registers and used to capture subsequent frames. In this manner the ISP and the camera control modules implement a feedback loop which constantly adjusts the camera parameters based on current operating conditions. The camera control modules 230, 232 may be implemented as separate instances which execute separate threads or as a single control module which utilizes a single processing thread.

Thus, described herein are exemplary systems and methods for stereo image capture in electronic devices. In some embodiments an electronic device may be equipped with multiple camera modules positioned to capture images of an object in a contemporaneous manner. Raw image data from the camera module is directed to an image signal processor interface, which combines the images on a line-by-line basis and feeds the combined lines to a single image signal processor pipeline, which processes the combined images into YUV image frames. The YUV image frames may be stored in memory and/or presented on a display.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
receiving a first set of lines of raw image data from a first camera module into a first receiver and a second set of lines of raw image data from a second camera module into a second receiver;
combining the first set of lines and the second set of lines to generate combined lines of raw image data;
processing the combined lines of raw image data; and
generating a combined image frame from the combined lines of raw image data.

2. The method of claim 1, wherein receiving a first set of lines of raw image data from a first camera module into a first receiver and a second set of lines of raw image data from a second camera module into a second receiver comprises receiving raw image data from each of the first camera module and the second camera module on a line-by-line basis, wherein lines of raw image data are separated by a blanking period.

3. The method of claim 1, wherein combining the first set of lines and the second set of lines to generate combined lines of raw image data comprises logically linking corresponding lines of raw image data from the first camera module and the second camera module into a single line.

4. The method of claim 1, wherein processing the combined lines of raw image data comprises converting one or more raw frames into one or more YUV video frames.

5. The method of claim 1, further comprising:
generating a first set of image statistics associated with the raw image data from the first camera module;
generating a second set of image statistics associated with the raw image data from the second camera module.

6. The method of claim 5, wherein the first camera control module is to:
receive the first set of image statistics and computes one or more camera control parameters from the first set of image statistics; and
receive the second set of image statistics and computes one or more camera control parameters from the second set of image statistics.

7. An electronic device, comprising:
a first camera module and a second camera module;
a first receiver to receive a first set of lines of raw image data from the first camera module;
a second receiver to receive a second set of lines of raw image data from the second camera module;
logic to:
combine the first set of lines and the second set of lines to generate combined lines of raw image data;
process the combined lines of raw image data; and
generate a combined image frame from the combined lines of raw image data.

8. The electronic device of claim 7, wherein:
the first receiver to receive raw image data from the first camera module on a line-by-line basis and the second receiver to receive raw image data from the second camera module, wherein lines of raw image data are separated by a blanking period.

9. The electronic device of claim 7, wherein the logic links corresponding lines of raw image data from the first camera module and the second camera module into a single line.

10. The electronic device of claim 7, further comprising logic to convert one or more raw frames into a corresponding number of YUV video frames.

11. The electronic device of claim 7, further comprising logic to generate:
a first set of image statistics associated with the raw image data from the first camera module;
a second set of image statistics associated with the raw image data from the second camera module.

12. The electronic device of claim 11, wherein:
the first camera control module is to receive the first set of image statistics and is to compute one or more camera control parameters from the first set of image statistics; and
the second camera control module is to receive the second set of image statistics and is to compute one or more camera control parameters from the second set of image statistics.

13. The electronic device of claim 7, comprising a display device on which to present the combined image frame.

14. An apparatus, comprising:
a first receiver to receive a first set of lines of raw image data from a first camera module;
a second receiver to receive a second set of lines of raw image data from a second camera module;
logic to:
combine the first set of lines and the second set of lines to generate combined lines of raw image data;
process the combined lines of raw image data; and
generate a combined image frame from the combined lines of raw image data.

15. The apparatus of claim 14, wherein:
the first receiver is to receive raw image data from the first camera module on a line-by-line basis and the second camera module is to receive raw image data from the second camera module on a line-by-line basis, wherein lines of raw image data are separated by a blanking period.

16. The apparatus of claim 14, further comprising logic to link corresponding lines of raw image data from the first camera module and the second camera module into a single line.

17. The apparatus of claim 14, further comprising logic to convert one or more raw frames into a corresponding number of YUV video frames.

18. The apparatus of claim 14, further comprising logic to:
generate a first set of image statistics associated with the raw image data from the first camera module;
generate a second set of image statistics associated with the raw image data from the second camera module;
forward the first set of image statistics to a first camera control module; and
forward the second set of image statistics to a second camera control module.

19. The apparatus of claim 18, wherein the first camera control module is to:
receive the first set of image statistics and computes one or more camera control parameters from the first set of image statistics; and
receive the second set of image statistics and computes one or more camera control parameters from the second set of image statistics.

20. The apparatus of claim 19, further a display device coupled to the electronic device on which to present the combined image frame.
